(19) United States
(12) Patent Application Publication
(10) Pub. No.: US 2022/0287168 A1
(43) Pub. Date: Sep. 8, 2022

(54) LIGHT CONTROL SYSTEM USING A MAT WITH WEIGHT SENSORS

(71) Applicant: MILDRED HUBBARD, Long Beach, CA (US)

(72) Inventor: MILDRED HUBBARD, Long Beach, CA (US)

(21) Appl. No.: 17/189,356

(22) Filed: Mar. 2, 2021

(51) Int. Cl. H05B 47/19; H05B 47/115; H02J 7/00

(52) U.S. Cl. CPC H05B 47/19; H05B 47/115; H02J 7/0042

(57) ABSTRACT

The light control system using a mat with weight sensors generates an illumination. The light control system using a mat with weight sensors remotely controls the generation of the illumination. The light control system using a mat with weight sensors comprises a lamp circuit, a carpet circuit, and a remote control circuit. The lamp circuit, the carpet circuit, and the remote control circuit are electrically interconnected. The lamp circuit generates an illumination that illuminates the vicinity surrounding the lamp circuit. The carpet circuit remotely controls the operation of the lamp circuit. The remote control circuit remotely controls the operation of the lamp circuit. By controlling the operation of the lamp circuit is meant: a) initiating the lamp circuit to illuminate the vicinity surround the lamp circuit; and, b) initiating the lamp circuit to extinguish the illumination of the vicinity surround the lamp circuit.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the field of electricity including circuit arrangements for a light source, more specifically, controlling a light source to respond to determined parameters. (H05B47/105)

### SUMMARY OF INVENTION

The light control system using a mat with weight sensors is an illumination control system. The light control system using a mat with weight sensors generates an illumination. The light control system using a mat with weight sensors remotely controls the generation of the illumination. The light control system using a mat with weight sensors comprises a lamp circuit, a carpet circuit, and a remote control circuit. The lamp circuit, the carpet circuit, and the remote control circuit are electrically interconnected. The lamp circuit generates an illumination that illuminates the vicinity surrounding the lamp circuit. The carpet circuit remotely controls the operation of the lamp circuit. The remote control circuit remotely controls the operation of the lamp circuit. By controlling the operation of the lamp circuit is meant: a) initiating the lamp circuit to illuminate the vicinity surround the lamp circuit; and, b) initiating the lamp circuit to extinguish the illumination of the vicinity surround the lamp circuit.

These together with additional objects, features and advantages of the light control system using a mat with weight sensors will be readily apparent to those of ordinary skill in the art upon reading the following detailed description of the presently preferred, but nonetheless illustrative, embodiments when taken in conjunction with the accompanying drawings.

In this respect, before explaining the current embodiments of the light control system using a mat with weight sensors in detail, it is to be understood that the light control system using a mat with weight sensors is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the light control system using a mat with weight sensors.

It is therefore important that the claims be regarded as including such equivalent construction insofar as they do not depart from the spirit and scope of the light control system using a mat with weight sensors. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is a front view of an embodiment of the disclosure.

FIG. 2 is a side view of an embodiment of the disclosure.

FIG. 3 is a top view of an embodiment of the disclosure.

FIG. 4 is a detail view of an embodiment of the disclosure.

FIG. 5 is a detail view of an embodiment of the disclosure.

FIG. 6 is a schematic view of an embodiment of the disclosure.

FIG. 7 is a schematic view of an embodiment of the disclosure.

FIG. 8 is a schematic view of an embodiment of the disclosure.

FIG. 9 is a schematic view of an embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

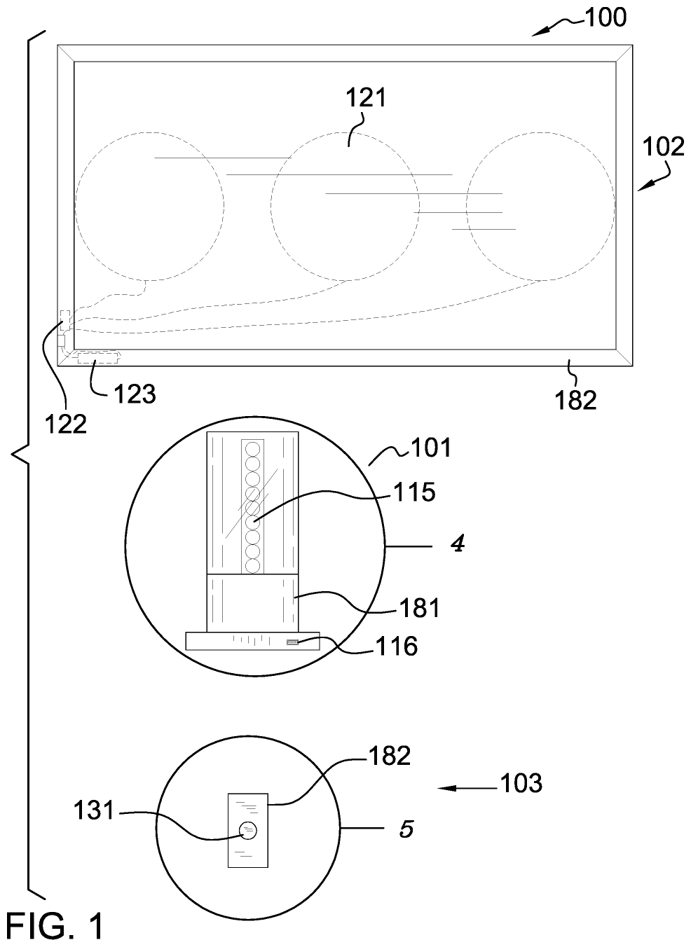

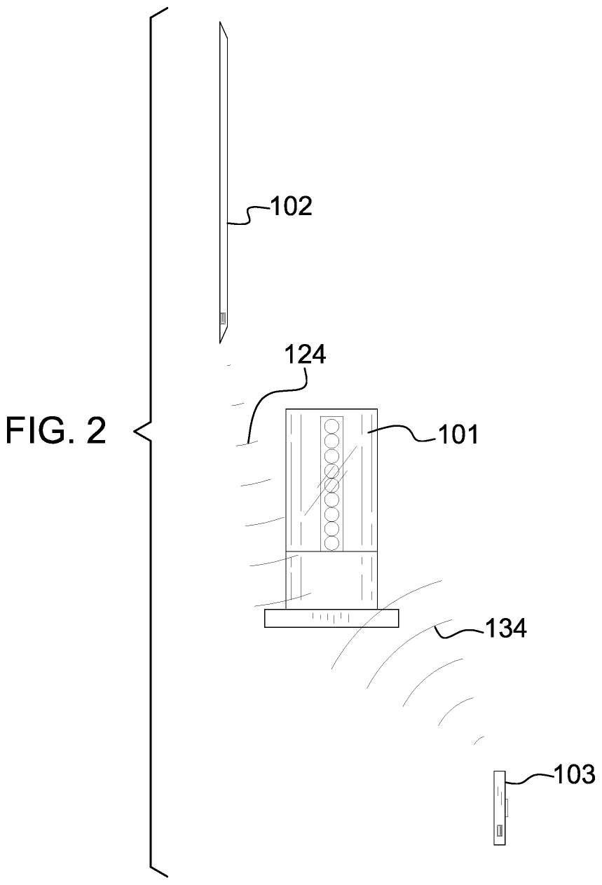

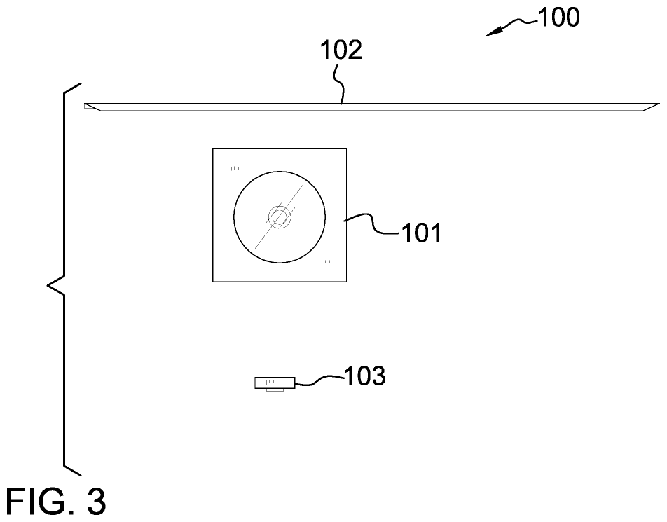

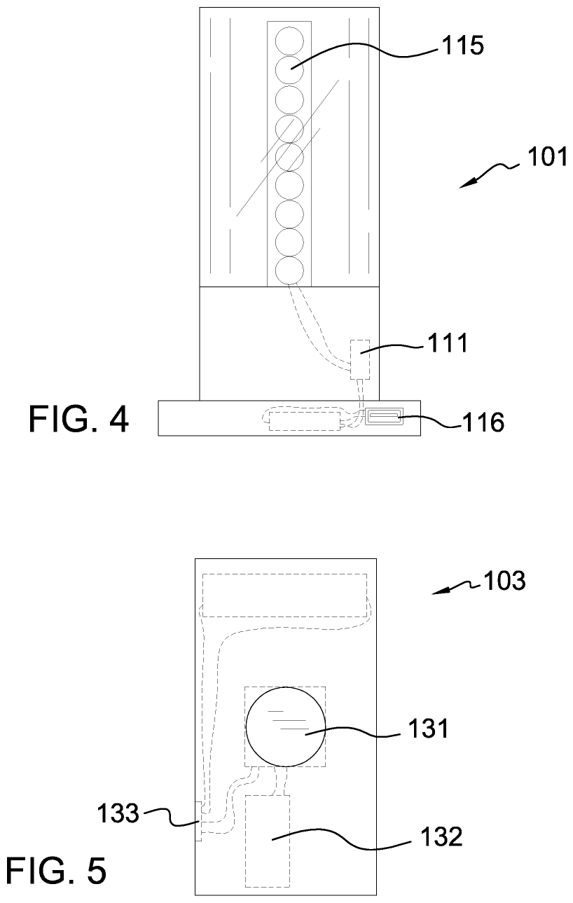

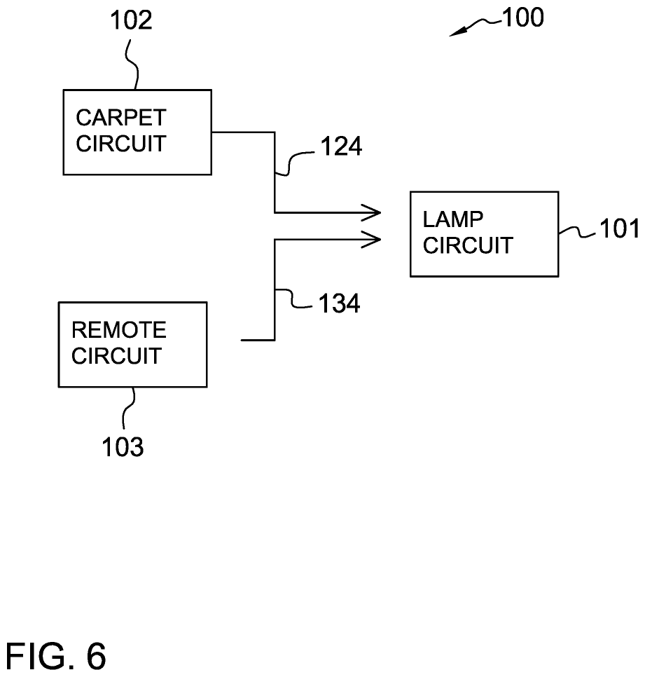

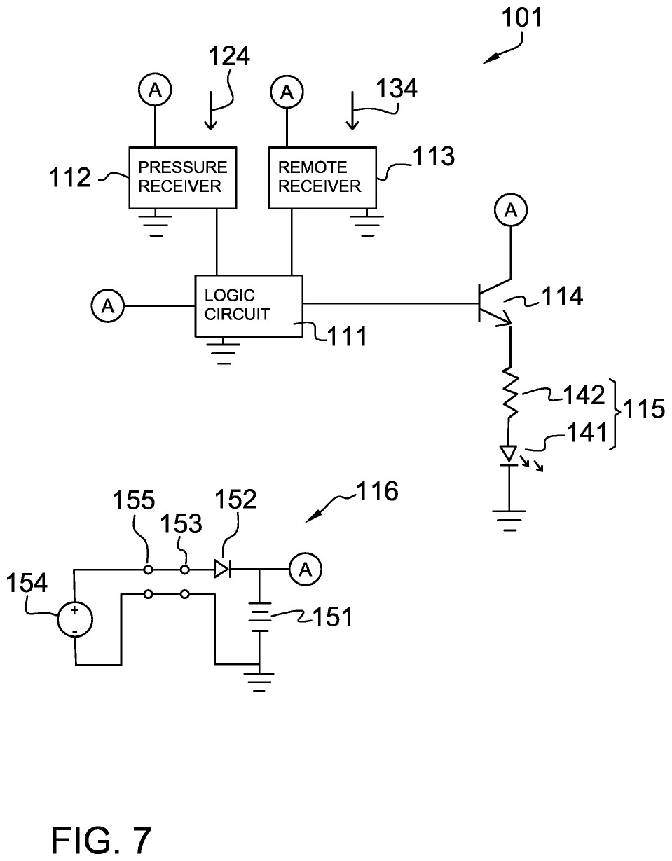

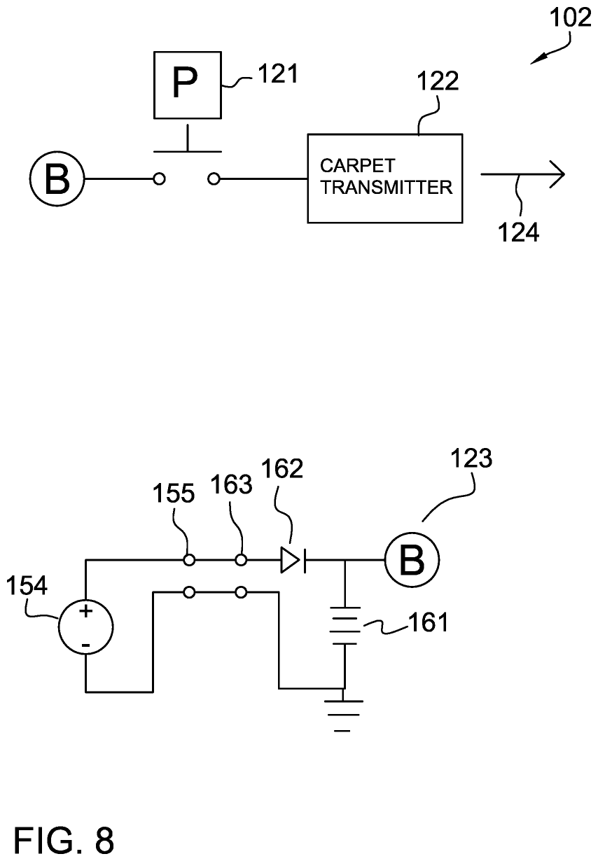

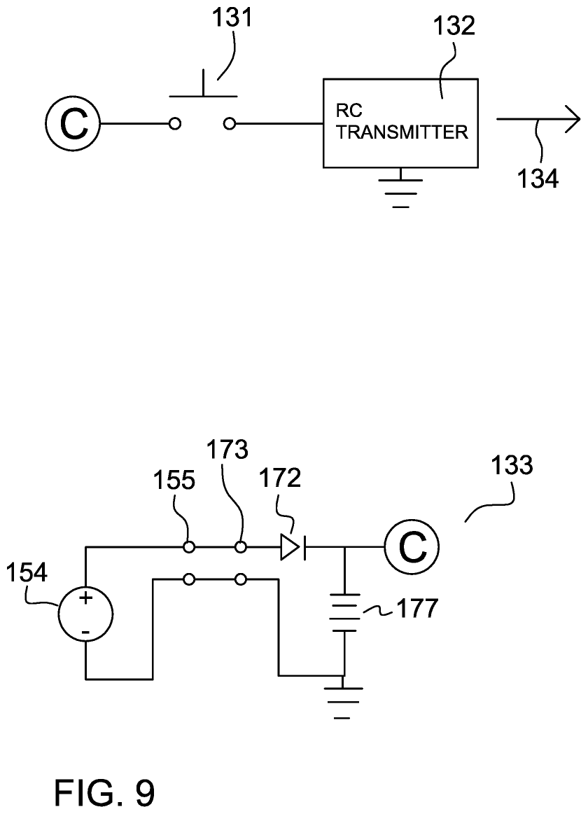

Detailed reference will now be made to one or more potential embodiments of the disclosure, which are illustrated in FIGS. 1 through 9.

The light control system using a mat with weight sensors 100 (hereinafter invention) is an illumination control system. The invention 100 generates an illumination. The invention 100 remotely controls the generation of the illumination. The invention 100 comprises a lamp circuit 101, a carpet 182 circuit 102, and a remote control circuit 103. The lamp circuit 101, the carpet 182 circuit 102, and the remote control circuit 103 are electrically interconnected. The lamp circuit 101 generates an illumination that illuminates the vicinity surrounding the lamp circuit 101. The carpet 182 circuit 102 remotely controls the operation of the lamp circuit 101. The remote control circuit 103 remotely controls the operation of the lamp circuit 101. By controlling the operation of the lamp circuit 101 is meant: a) initiating the lamp circuit 101 to illuminate the vicinity surrounding the lamp circuit 101; and, b) initiating the lamp circuit 101 to extinguish the illumination of the vicinity surrounding the lamp circuit 101.

The lamp circuit 101 is an electric circuit. The lamp circuit 101 generates an illumination in the vicinity of the lamp circuit 101. The carpet 182 circuit 102 remotely controls the operation of the lamp circuit 101 via a radio frequency communication link. Specifically, the carpet 182 circuit 102 initiates the illumination of the lamp circuit 101. The carpet 182 circuit 102 extinguishes the illumination of the lamp circuit 101. The remote control circuit 103 remotely controls the operation of the lamp circuit 101 via a radio frequency communication link. Specifically, the remote control circuit 103 initiates the illumination of the lamp circuit 101. The remote control circuit 103 extinguishes the illumination of the lamp circuit 101. The lamp circuit 101 is an independently powered electric circuit. By independently powered is meant that the lamp circuit 101 can operate without an electrical connection to an external power source 154.

The lamp circuit 101 comprises a logic circuit 111, a carpet 182 receiver 112, a remote receiver 113, a transistor 114, an illumination circuit 115, a lamp power circuit 116, and a lamp housing 181. The logic circuit 111, the carpet 182 receiver 112, the remote receiver 113, the transistor 114, the illumination circuit 115, and the lamp power circuit 116 are electrically connected.

The lamp housing 181 is a rigid structure. The lamp housing 181 contains the logic circuit 111, the carpet 182 receiver 112, the remote receiver 113, the transistor 114, the illumination circuit 115, and the lamp power circuit 116. The lamp housing 181 is formed with all apertures and form factors necessary to allow the lamp housing 181 to accommodate the use and operation of the lamp circuit 101. Methods to form a lamp housing 181 suitable for the purposes described in this disclosure are well-known and documented in the mechanical arts.

The logic circuit 111 is an electric circuit. The logic circuit 111 controls the illumination of the lamp circuit 101.

This paragraph and the following paragraph describe the actions taken by the logic circuit 111. The logic circuit 111 alternates the illumination circuit 115 between an illuminated state and an extinguished state. The logic circuit 111 alternates the state of the illumination circuit 115 whenever it receives a control signal from a receiver selected from the group consisting of: a) the carpet 182 receiver 112; and, b) the remote receiver 113. The logic circuit 111 controls the state of the illumination circuit 115 using the transistor 114.

Specifically, the logic circuit 111 changes the illumination circuit 115 from an extinguished state to an illuminated state when the carpet 182 receiver 112 transmits to the logic circuit 111 that the carpet 182 receiver 112 has received a control signal from the carpet 182 circuit 102. The logic circuit 111 changes the illumination circuit 115 from an extinguished state to an illuminated state when the remote receiver 113 transmits to the logic circuit 111 that the remote receiver 113 has received a control signal from the remote control circuit 103. Similarly, the logic circuit 111 changes the illumination circuit 115 from an illuminated state to an extinguished state when the carpet 182 receiver 112 transmits to the logic circuit 111 that the carpet 182 receiver 112 has received a control signal from the carpet 182 circuit 102. The logic circuit 111 changes the illumination circuit 115 from an illuminated state to an extinguished state when the remote receiver 113 transmits to the logic circuit 111 that the remote receiver 113 has received a control signal from the remote control circuit 103.

The logic circuit 111 electrically connects to the carpet 182 receiver 112. The carpet 182 receiver 112 is a radio frequency receiver that allows the logic circuit 111 to receive control signals from the carpet 182 circuit 102. Specifically, the carpet 182 receiver 112 establishes a carpet 182 wireless communication link 124 between the lamp circuit 101 and the carpet 182 transmitter 122 of the carpet 182 circuit 102. The carpet 182 transmitter 122 transmits the control signal using the carpet 182 wireless communication link 124 that causes the logic circuit 111 to take an action selected from the group consisting of: a) illuminating the illumination circuit 115 of the lamp circuit 101; and, b) or extinguishing the illumination circuit 115 of the lamp circuit 101. In the first potential embodiment of the disclosure, the carpet 182 receiver 112 receives a 433 MHz radio signal from the carpet 182 transmitter 122.

The logic circuit 111 electrically connects to the remote receiver 113. The remote receiver 113 is a radio frequency receiver that allows the logic circuit 111 to receive control signals from the remote control circuit 103. Specifically, the remote receiver 113 establishes a remote wireless communication link 134 between the lamp circuit 101 and the remote transmitter 132 of the remote control circuit 103. The remote transmitter 132 transmits the control signal using the remote wireless communication link 134 that causes the logic circuit 111 to take an action selected from the group consisting of: a) illuminating the illumination circuit 115 of the lamp circuit 101; and, b) or extinguishing the illumination circuit 115 of the lamp circuit 101. In the first potential embodiment of the disclosure, the remote receiver 113 receives a 433 MHz radio signal from the remote transmitter 132.

The illumination circuit 115 is an electric circuit. The logic circuit 111 controls the operation of the illumination circuit 115 by using the transistor 114 to control the flow of electricity through the illumination circuit 115. The logic circuit 111 illuminates the illumination circuit 115 by allowing the flow of electricity from the lamp power circuit 116 through the illumination circuit 115. The logic circuit 111 extinguishes the illumination circuit 115 by discontinuing the flow of electricity from the lamp power circuit 116 through the illumination circuit 115. The illumination circuit 115 further comprises one or more LEDs 141 and a limit resistor 142. The transistor 114, the one or more LEDs 141, the limit resistor 142, and the lamp power circuit 116 electrically connect to form a series electric circuit.

Each of the one or more LEDs 141 is an electric circuit element. Each LED selected from the one or more LEDs 141 generates an illumination that is visible from the exterior of the lamp housing 181 when an electric current flows through the selected LED. The limit resistor 142 is a resistive circuit element. The limit resistor 142 is wired in series with the one or more LEDs 141. The limit resistor 142 limits the flow of electricity through the one or more LEDs 141.

The transistor 114 is an electric circuit element. The transistor 114 operates as an electrically controlled switch. The transistor 114 controls the flow of electricity from the lamp power circuit 116 into the illumination circuit 115. When the logic circuit 111 applies a voltage to the transistor 114 base, current will flow into the transistor 114 base and the transistor 114 will act like a closed switch allowing current to flow from the transistor 114 collector and through the transistor 114 emitter thereby illuminating the illumination circuit 115. When the logic circuit 111 removes the voltage from the transistor 114 base, the transistor 114 will act like an open switch disrupting current flow from the transistor 114 collector to the transistor 114 emitter thereby extinguishing the illumination circuit 115.

The lamp power circuit 116 is an electrical circuit. The lamp power circuit 116 powers the operation of the lamp circuit 101. The lamp power circuit 116 is an electrochemical device. The lamp power circuit 116 converts chemical potential energy into the electrical energy required to power the lamp circuit 101. The lamp power circuit 116 comprises a lamp battery 151, a lamp diode 152, a lamp charging port 153, and an external power source 154. The external power source 154 further comprises a charging plug 155. The lamp battery 151, the lamp diode 152, the lamp charging port 153, the external power source 154, and the charging plug 155 are electrically interconnected.

The lamp battery 151 is an electrochemical device. The lamp battery 151 converts chemical potential energy into the electrical energy used to power the lamp circuit 101. The lamp battery 151 is a commercially available rechargeable lamp battery 151. The chemical energy stored within the rechargeable lamp battery 151 is renewed and restored through the use of the lamp charging port 153. The lamp charging port 153 is an electrical circuit that reverses the polarity of the rechargeable lamp battery 151 and provides the energy necessary to reverse the chemical processes that the rechargeable lamp battery 151 initially used to generate the electrical energy. This reversal of the chemical process creates a chemical potential energy that will later be used by the rechargeable lamp battery 151 to generate electricity.

The lamp charging port 153 forms an electrical connection to an external power source 154 using a charging plug 155. The charging plug 155 forms a detachable electrical connection with the lamp charging port 153. The lamp charging port 153 receives electrical energy from the external power source 154 through the charging plug 155. The lamp diode 152 is an electrical device that allows current to flow in only one direction. The lamp diode 152 installs between the rechargeable lamp battery 151 and the lamp charging port 153 such that electricity will not flow from the positive terminal of the rechargeable lamp battery 151 into the positive terminal of the external power source 154.

The carpet 182 circuit 102 is an electric circuit. The carpet 182 circuit 102 generates a radio frequency control signal that initiates the lamp circuit 101 to take an action selected from the group consisting of: a) illuminating the lamp circuit 101 is the lamp circuit 101 is currently extinguished; and, b) extinguishing the illumination of the lamp circuit 101 if the lamp circuit 101 is currently illuminated. The carpet 182 circuit 102 is an independently powered electric circuit. By independently powered is meant that the carpet 182 circuit 102 can operate without an electrical connection to an external power source 154.

The carpet 182 circuit 102 comprises a pressure plate switch 121, a carpet 182 transmitter 122, a carpet 182 power circuit 123, and a carpet 182 The carpet 182 transmitter 122 further comprises a carpet 182 wireless communication link 124. The pressure plate switch 121, the carpet 182 transmitter 122, and the carpet 182 power circuit 123 are electrically interconnected. The carpet 182 wireless communication link 124 forms a communication link between the carpet 182 transmitter 122 and the carpet 182 receiver 112 of the lamp circuit 101.

The carpet 182 is a textile structure. The carpet 182 is defined elsewhere in this disclosure. The carpet 182 is defined elsewhere in this disclosure. The pressure plate switch 121, the carpet 182 transmitter 122, and the carpet 182 power circuit 123 are mounted in the carpet 182. The carpet 182 is formed with all the arrangements necessary to allow the carpet 182 to accommodate the use and operation of the carpet 182 circuit 102. Methods to form a carpet 182 suitable for the purposes described in this disclosure are well-known and documented in the mechanical arts.

The pressure plate switch 121 is an electric switching device. The pressure plate switch 121 is defined elsewhere in this disclosure. The pressure plate switch 121 is a momentary switch. The pressure plate switch 121 is a normally open switch. The pressure plate switch 121 mounts in the carpet 182. The pressure plate switch 121 is a pressure actuated switch that actuates to the closed position when the carpet 182 is stepped on. The pressure plate switch 121 forms a series electric connection between the carpet 182 power circuit 123 and the carpet 182 transmitter 122.

The carpet 182 transmitter 122 is a radio frequency transmitter. The actuation of the pressure plate switch 121 to the closed position allows electricity to flow from the carpet 182 power circuit 123 into the carpet 182 transmitter 122. The actuation of the pressure plate switch 121 initiates the carpet 182 transmitter 122 to establish the carpet 182 wireless communication link 124 with the carpet 182 receiver 112 which transmits a control signal to the lamp circuit 101.

The carpet 182 power circuit 123 is an electrical circuit. The carpet 182 power circuit 123 powers the operation of the carpet 182 circuit 102. The carpet 182 power circuit 123 is an electrochemical device. The carpet 182 power circuit 123 converts chemical potential energy into the electrical energy required to power the carpet 182 circuit 102. The carpet 182 power circuit 123 comprises a carpet 182 battery 161, a carpet 182 diode 162, a carpet 182 charging port 163, and the external power source 154. The external power source 154 further comprises a charging plug 155. The carpet 182 battery 161, the carpet 182 diode 162, the carpet 182 charging port 163, the external power source 154, and the charging plug 155 are electrically interconnected.

The carpet 182 battery 161 is an electrochemical device. The carpet 182 battery 161 converts chemical potential energy into the electrical energy used to power the carpet 182 circuit 102. The carpet 182 battery 161 is a commercially available rechargeable carpet 182 battery 161. The chemical energy stored within the rechargeable carpet 182 battery 161 is renewed and restored through the use of the carpet 182 charging port 163. The carpet 182 charging port 163 is an electrical circuit that reverses the polarity of the rechargeable carpet 182 battery 161 and provides the energy necessary to reverse the chemical processes that the rechargeable carpet 182 battery 161 initially used to generate the electrical energy. This reversal of the chemical process creates a chemical potential energy that will later be used by the rechargeable carpet 182 battery 161 to generate electricity.

The carpet 182 charging port 163 forms an electrical connection to an external power source 164 using a charging plug 155. The charging plug 155 forms a detachable electrical connection with the carpet 182 charging port 163. The carpet 182 charging port 163 receives electrical energy from the external power source 164 through the charging plug 155. The carpet 182 diode 162 is an electrical device that allows current to flow in only one direction. The carpet 182 diode 162 installs between the rechargeable carpet 182 battery 161 and the carpet 182 charging port 163 such that electricity will not flow from the positive terminal of the rechargeable carpet 182 battery 161 into the positive terminal of the external power source 164.

The remote control circuit 103 is an electric circuit. The remote control circuit 103 generates a radio frequency control signal that initiates the lamp circuit 101 to take an action selected from the group consisting of: a) illuminating the lamp circuit 101 is the lamp circuit 101 is currently extinguished; and, b) extinguishing the illumination of the lamp circuit 101 if the lamp circuit 101 is currently illuminated. The remote control circuit 103 is an independently powered electric circuit. By independently powered is meant that the remote control circuit 103 can operate without an electrical connection to the external power source 154.

The remote control circuit 103 comprises a remote switch 131, a remote transmitter 132, a remote power circuit 133, and a remote housing 183. The remote transmitter 132 further comprises a remote wireless communication link 134. The remote switch 131, the remote transmitter 132, and the remote power circuit 133 are electrically interconnected. The remote wireless communication link 134 forms a communication link between the remote transmitter 132 and the remote receiver 113 of the lamp circuit 101.

The remote housing 183 is a rigid structure. The remote housing 183 contains the remote switch 131, the remote transmitter 132, and the remote power circuit 133. The remote housing 183 is formed with all apertures and form factors necessary to allow the remote housing 183 to accommodate the use and operation of the remote control circuit 103. Methods to form a remote housing 183 suitable for the purposes described in this disclosure are well-known and documented in the mechanical arts.

The remote switch 131 is an electric switching device. The remote switch 131 is a momentary switch. The remote switch 131 is a normally open switch. The remote switch 131 mounts in the remote housing 183. The remote switch 131 is a pressure actuated switch that actuates to the closed position when the remote switch 131 is pushed. The remote switch 131 forms a series electric connection between the remote power circuit 133 and the remote transmitter 132.

The remote transmitter 132 is a radio frequency transmitter. The actuation of the remote switch 131 to the closed position allows electricity to flow from the remote power circuit 133 into the remote transmitter 132. The actuation of the remote switch 131 initiates the remote transmitter 132 to establish the remote wireless communication link 134 with the remote receiver 113 which transmits a control signal to the lamp circuit 101.

The remote power circuit 133 is an electrical circuit. The remote power circuit 133 powers the operation of the remote control circuit 103. The remote power circuit 133 is an electrochemical device. The remote power circuit 133 converts chemical potential energy into the electrical energy required to power the remote control circuit 103. The remote power circuit 133 comprises a remote battery 171, a remote diode 172, a remote charging port 173, and the external power source 154. The external power source 154 further comprises a charging plug 155. The remote battery 171, the remote diode 172, the remote charging port 173, the external power source 154, and the charging plug 155 are electrically interconnected.

The remote control battery 171 is an electrochemical device. The remote control battery 171 converts chemical potential energy into the electrical energy used to power the remote control circuit 103. The remote control battery 171 is a commercially available rechargeable remote control battery 171. The chemical energy stored within the rechargeable remote control battery 171 is renewed and restored through the use of the remote control charging port 173. The remote control charging port 173 is an electrical circuit that reverses the polarity of the rechargeable remote control battery 171 and provides the energy necessary to reverse the chemical processes that the rechargeable remote control battery 171 initially used to generate the electrical energy. This reversal of the chemical process creates a chemical potential energy that will later be used by the rechargeable remote control battery 171 to generate electricity.

The remote control charging port 173 forms an electrical connection to the external power source 154 using a charging plug 155. The charging plug 155 forms a detachable electrical connection with the remote control charging port 173. The remote control charging port 173 receives electrical energy from the external power source 154 through the charging plug 155. The remote control diode 172 is an electrical device that allows current to flow in only one direction. The remote control diode 172 installs between the rechargeable remote control battery 171 and the remote control charging port 173 such that electricity will not flow from the positive terminal of the rechargeable remote control battery 171 into the positive terminal of the external power source 154.

The following definitions were used in this disclosure:

Battery: As used in this disclosure, a battery is a chemical device consisting of one or more cells, in which chemical energy is converted into electricity and used as a source of power. Batteries are commonly defined with a positive terminal and a negative terminal.

Carpet: As used in this disclosure, a carpet is a textile based sheeting that is used to cover a floor.

Communication Link: As used in this disclosure, a communication link refers to the structured exchange of data between two objects.

Control Circuit: As used in this disclosure, a control circuit is an electrical circuit that manages and regulates the behavior or operation of a device.

Diode: As used in this disclosure, a diode is a two terminal semiconductor device that allows current flow in only one direction. The two terminals are called the anode and the cathode. Electric current is allowed to pass from the anode to the cathode.

External Power Source: As used in this disclosure, an external power source is a source of the energy that is externally provided to enable the operation of the present disclosure. Examples of external power sources include, but are not limited to, electrical power sources and compressed air sources.

Extinguish: As used in this disclosure, to extinguish means to cause a device to stop generating an illumination.

Force: As used in this disclosure, a force refers to a net (or unopposed) measurable interaction that changes the direction of motion of an object, the velocity of motion of an object, the momentum of an object, or the stress within an object.

Force Sensor: As used in this disclosure, the force sensor is a sensor that generates an electrically measurable signal that is a function of the amount of force applied to the force sensor. The force sensor is often referred to as a pressure sensor. The force sensor commonly measures force using the piezoelectric effect generated by the deformation of a material.

Housing: As used in this disclosure, a housing is a rigid structure that encloses and protects one or more devices.

Illumination: As used in this disclosure, illumination refers to electromagnetic radiation contained with an area. Illumination is a synonym for light, particularly in cases where a measure of the amount of visible electromagnetic radiation in a space is called for. The verb form of illumination is to illuminate and is taken to mean the generation of an illumination.

LED: As used in this disclosure, an LED is an acronym for a light emitting diode. A light emitting diode is a diode that is also a light source.

Limit Resistor: As used in this disclosure, a limit resistor is an electrical resistor that is used to limit the flow of electric current through an electrical circuit.

Logic Circuit: As used in this disclosure, a logic circuit is non-programmable electrical device that receives one or more digital or analog inputs and uses those digital or analog inputs to generate one or more digital or analog outputs.

Maintained Switch: A used in this disclosure, a maintained switch is a switch that maintains the position that was set in the most recent switch actuation. A maintained switch works in an opposite manner to a momentary switch.

Mass: As used in this disclosure, refers to a quantity of matter within a structure. Mass is measured and quantified by the reaction of the structure to a force. Mass can also be roughly quantified as a function of atomic composition and the number of atoms contained within the structure. The term weight refers to the quantification of a mass that is exposed to the force of gravity.

Momentary Switch: As used in this disclosure, a momentary switch is a biased switch in the sense that the momentary switch has a baseline position that only changes when the momentary switch is actuated (for example when a pushbutton switch is pushed or a relay coil is energized). The momentary switch then returns to the baseline position once the actuation is completed. This baseline position is called the “normal” position. For example, a “normally open” momentary switch interrupts (open) the electric circuit in the baseline position and completes (closes) the circuit when the momentary switch is activated. Similarly, a “normally closed” momentary switch will complete (close) an electric circuit in the baseline position and interrupt (open) the circuit when the momentary switch is activated.

Normally Closed: As used in this disclosure, normally closed refers to an externally controlled electrical switching device, such as a relay or a momentary switch, which passes electric current when the externally controlled electrical switching device is in an unpowered state. In a common alternate usage, the term normally closed valve is taken to mean that the normally closed valve prevents the flow of fluid through the normally closed valve when the normally closed valve is in an unpowered state.

Normally Open: As used in this disclosure, normally open refers to an externally controlled electrical switching device, such as a relay or a momentary switch, which does not pass electric current when the externally controlled electrical switching device is in an unpowered state. In a common alternate usage, the term normally open valve is taken to mean that the normally open valve allows the flow of fluid through the normally open valve when the normally open valve is in an unpowered state.

Plug: As used in this disclosure, a plug is an electrical termination that electrically connects a first electrical circuit to a second electrical circuit or a source of electricity. As used in this disclosure, a plug will have two or three metal pins.

Port: As used in this disclosure, a port is an electrical termination that is used to connect a first electrical circuit to a second external electrical circuit. In this disclosure, the port is designed to receive a plug.

Pressure: As used in this disclosure, pressure refers to a measure of force per unit area.

Pressure Plate Switch: As used in this disclosure, a pressure plate switch is a commercially available switching device wherein a switch is placed underneath a flexible or semi-rigid surface such that when pressure is applied to or removed from the flexible or semi-rigid surface the underlying switch is actuated. An example of a commercially marketed pressure switch is commonly marketed as a bed alarm with a sensor pad for dementia patients. The sensor pad is commonly a pressure switch.

Pressure Switch: As used in this disclosure, a pressure switch is an electrical switch that actuates by an applied pressure. Pressure switches are commercially available.

Receiver: As used in this disclosure, a receiver is an electric device that is used to receive and demodulate electromagnetic radiation such as radio signals.

Relay: As used in this disclosure, a relay is an automatic electronic, electromagnetic, or electromechanical device that reacts to changes in voltage or current by opening or closing a switch in an electric circuit. Relays are further defined with a coil and a switch. Applying a voltage to the coil, usually referred to as energizing the coil, will cause the coil to change the position of the switch. This definition is not intended to preclude the substitution of a transistor for a relay. Within this disclosure, a transistor can be considered as a relay. In this scenario, the base voltage is analogous to the coil of the relay and the current flow from the collector to the emitter is analogous to the operation of the switch of the relay. Those skilled in the electrical arts will recognize that this substitution can be made without undue experimentation. The transistor is defined in greater detail elsewhere in this disclosure.

Remote Control: As used in this disclosure, remote control means the establishment of control of a device from a distance. Remote control is generally accomplished through the use of an electrical device that generates electrically based control signals that are transmitted via radio frequencies or other means to the device.

Resistance: As used in this disclosure, resistance refers to the opposition provided by an electrical circuit (or circuit element) to the electrical current created by a DC voltage is presented across the electrical circuit (or circuit element). The term impedance is often used for resistance when referring to an AC voltage that is presented across the electrical circuit (or circuit element).

Resistor: As used in this disclosure, a resistor is a well-known and commonly available electrical device that presents a resistance that inhibits the flow of electricity through an electric circuit. Within an electric circuit processing alternating currents, the resistor will not affect the phase of the alternating current. A current flowing through a resistor will create a voltage across the terminals of the resistor.

Sensor: As used in this disclosure, a sensor is a device that receives and responds in a predetermined way to a signal or stimulus. As further used in this disclosure, a threshold sensor is a sensor that generates a signal that indicates whether the signal or stimulus is above or below a given threshold for the signal or stimulus.

Series Circuit: As used in this disclosure, a series circuit refers to a method of electrically connecting a plurality of circuit elements to a voltage source. In a series circuit, the proportion of the voltage received by each individual circuit element is divided proportionally between the plurality circuit elements based on the resistance (or impedance) of each circuit element relative to the total resistance of the plurality of circuit elements. The series circuit forms a linear or loop structure often referred to as a daisy chain.

Sheeting: As used in this disclosure, a sheeting is a material, such as a paper, textile, a plastic, or a metal foil, in the form of a thin flexible layer or layers. The sheeting forms a disk structure. The two surfaces of the sheeting with the greatest surface area are called the faces of the sheeting.

Switch: As used in this disclosure, a switch is an electrical device that starts and stops the flow of electricity through an electric circuit by completing or interrupting an electric circuit. The act of completing or breaking the electrical circuit is called actuation. Completing or interrupting an electric circuit with a switch is often referred to as closing or opening a switch respectively. Completing or interrupting an electric circuit is also often referred to as making or breaking the circuit respectively.

Textile: As used in this disclosure, a textile is a material that is woven, knitted, braided or felted. Synonyms in common usage for this definition include fabric and cloth. The two surfaces of the textile with the greatest surface area are called the faces of the textile.

Transistor: As used in this disclosure, a transistor is a general term for a three terminal semiconducting electrical device that is used for electrical signal amplification and electrical switching applications. There are several designs of transistors. A common example of a transistor is an NPN transistor that further comprises a collector terminal, an emitter terminal, and a base terminal and which consists of a combination of two rectifying junctions (a diode is an example of a rectifying junction). Current flowing from the collector terminal through the emitter terminal crosses the two rectifier junctions. The amount of the electric current crossing the two rectified junctions is controlled by the amount of electric current that flows through the base terminal. This disclosure assumes the use of an NPN transistor. This assumption is made solely for the purposes of simplicity and clarity of exposition. Those skilled in the electrical arts will recognize that other types of transistors, including but not limited to, field effect transistors and PNP transistors, can be substituted for an NPN transistor without undue experimentation.

Transmitter: As used in this disclosure, a transmitter is a device that is used to generate and transmit electromagnetic radiation such as radio signals.

USB: As used in this disclosure, USB is an acronym for Universal Serial Bus which is an industry standard that defines the cables, the connectors, the communication protocols and the distribution of power required for interconnections between electronic devices. The USB standard defines several connectors including, but not limited to, USB-A, USB-B, mini-USB, and micro USB connectors. A USB cable refers to a cable that: 1) is terminated with USB connectors; and, 2) that meets the data transmission standards of the USB standard.

Vicinity: As used in this disclosure, vicinity refers to the space immediately, or closely, surrounding a first object. A second object is said to be in the vicinity of the first object.

Wireless: As used in this disclosure, wireless is an adjective that is used to describe a communication link between two devices that does not require the use of physical cabling.

With respect to the above description, it is to be realized that the optimum dimensional relationship for the various components of the invention described above and in FIGS. 1 through 9 include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

What is claimed is:

1. A light control system comprising
a lamp circuit, a carpet circuit, and a remote control circuit;
wherein the lamp circuit, the carpet circuit, and the remote control circuit are electrically interconnected;
wherein the lamp circuit generates an illumination that illuminates the vicinity surrounding the lamp circuit;
wherein the light control system remotely controls the generation of the illumination.

2. The light control system according to claim 1
wherein the carpet circuit remotely controls the operation of the lamp circuit;
wherein the remote control circuit remotely controls the operation of the lamp circuit;
wherein by controlling the operation of the lamp circuit is meant: a) initiating the lamp circuit to illuminate the vicinity surrounding the lamp circuit; and, b) initiating the lamp circuit to extinguish the illumination of the vicinity surrounding the lamp circuit.

3. The light control system according to claim 2
wherein the lamp circuit is an electric circuit;
wherein the lamp circuit generates an illumination in the vicinity of the lamp circuit;
wherein the carpet circuit remotely controls the operation of the lamp circuit via a radio frequency communication link;
wherein the carpet circuit initiates the illumination of the lamp circuit;
wherein the carpet circuit extinguishes the illumination of the lamp circuit;
wherein the remote control circuit remotely controls the operation of the lamp circuit via a radio frequency communication link;
wherein the remote control circuit initiates the illumination of the lamp circuit;
wherein the remote control circuit extinguishes the illumination of the lamp circuit;
wherein the lamp circuit is an independently powered electric circuit;
wherein by independently powered is meant that the lamp circuit can operate without an electrical connection to an external power source.

4. The light control system according to claim 3
wherein the carpet circuit is an electric circuit;
wherein the carpet circuit generates a radio frequency control signal that initiates the lamp circuit to take an action selected from the group consisting of: a) illuminating the lamp circuit is the lamp circuit is currently extinguished; and, b) extinguishing the illumination of the lamp circuit if the lamp circuit is currently illuminated;
wherein the carpet circuit is an independently powered electric circuit;
wherein by independently powered is meant that the carpet circuit can operate without an electrical connection to an external power source.

5. The light control system according to claim 4
wherein the remote control circuit is an electric circuit;
wherein the remote control circuit generates a radio frequency control signal that initiates the lamp circuit to take an action selected from the group consisting of: a) illuminating the lamp circuit is the lamp circuit is currently extinguished; and, b) extinguishing the illumination of the lamp circuit if the lamp circuit is currently illuminated;
wherein the remote control circuit is an independently powered electric circuit;
wherein by independently powered is meant that the remote control circuit can operate without an electrical connection to the external power source.

6. The light control system according to claim 5
wherein the lamp circuit comprises a logic circuit, a carpet receiver, a remote receiver, a transistor, an illumination circuit, a lamp power circuit, and a lamp housing;
wherein the logic circuit, the carpet receiver, the remote receiver, the transistor, the illumination circuit, and the lamp power circuit are electrically connected;
wherein the carpet circuit comprises a pressure plate switch, a carpet transmitter, a carpet power circuit, and a carpet the carpet transmitter further comprises a carpet wireless communication link;
wherein the pressure plate switch, the carpet transmitter, and the carpet power circuit are electrically interconnected;
wherein the carpet wireless communication link forms a communication link between the carpet transmitter and the carpet receiver of the lamp circuit;
wherein the remote control circuit comprises a remote switch, a remote transmitter, a remote power circuit, and a remote housing;
wherein the remote transmitter further comprises a remote wireless communication link;
wherein the remote switch, the remote transmitter, and the remote power circuit are electrically interconnected;
wherein the remote wireless communication link forms a communication link between the remote transmitter and the remote receiver of the lamp circuit.

7. The light control system according to claim 6
wherein the lamp housing is a rigid structure;
wherein the lamp housing contains the logic circuit, the carpet receiver, the remote receiver, the transistor, the illumination circuit, and the lamp power circuit;
wherein the carpet is a textile structure;
wherein the pressure plate switch, the carpet transmitter, and the carpet power circuit are mounted in the carpet;
wherein the remote housing is a rigid structure;
wherein the remote housing contains the remote switch, the remote transmitter, and the remote power circuit.

8. The light control system according to claim 7
wherein the logic circuit is an electric circuit;
wherein the logic circuit controls the illumination of the lamp circuit;
wherein the logic circuit alternates the illumination circuit between an illuminated state and an extinguished state;
wherein the logic circuit alternates the state of the illumination circuit whenever it receives a control signal from a receiver selected from the group consisting of: a) the carpet receiver; and, b) the remote receiver;
wherein the logic circuit controls the state of the illumination circuit using the transistor.

9. The light control system according to claim 8
wherein the carpet receiver is a radio frequency receiver that allows the logic circuit to receive control signals from the carpet circuit;
wherein the carpet receiver establishes a carpet wireless communication link between the lamp circuit and the carpet circuit;
wherein the remote receiver is a radio frequency receiver that allows the logic circuit to receive control signals from the remote control circuit;
wherein the remote receiver establishes a remote wireless communication link between the lamp circuit and the remote control circuit.

10. The light control system according to claim 9
wherein the illumination circuit is an electric circuit;
wherein the logic circuit controls the operation of the illumination circuit by using the transistor to control the flow of electricity through the illumination circuit;
wherein the logic circuit illuminates the illumination circuit by allowing the flow of electricity from the lamp power circuit through the illumination circuit;
wherein the logic circuit extinguishes the illumination circuit by discontinuing the flow of electricity from the lamp power circuit through the illumination circuit.

11. The light control system according to claim 10
wherein the transistor is an electric circuit element;
wherein the transistor operates as an electrically controlled switch;
wherein the logic circuit controls the operation of the transistor;
wherein the transistor controls the flow of electricity from the lamp power circuit into the illumination circuit;
wherein the lamp power circuit is an electrical circuit;
wherein the lamp power circuit powers the operation of the lamp circuit.

12. The light control system according to claim 11
wherein the pressure plate switch is an electric switching device;
wherein the pressure plate switch is a momentary switch;
wherein the pressure plate switch is a normally open switch;
wherein the pressure plate switch mounts in the carpet;
wherein the pressure plate switch is a pressure actuated switch that actuates to the closed position when the carpet is stepped on;
wherein the pressure plate switch forms a series electric connection between the carpet power circuit and the carpet transmitter;
wherein the carpet transmitter is a radio frequency transmitter;
wherein the actuation of the pressure plate switch to the closed position allows electricity to flow from the carpet power circuit into the carpet transmitter;
wherein the actuation of the pressure plate switch initiates the carpet transmitter to establish the carpet wireless communication link with the carpet receiver;
wherein the carpet power circuit is an electrical circuit;
wherein the carpet power circuit powers the operation of the carpet circuit.

13. The light control system according to claim 12
wherein the remote switch is an electric switching device;
wherein the remote switch is a momentary switch;
wherein the remote switch is a normally open switch;
wherein the remote switch mounts in the remote housing;
wherein the remote switch is a pressure actuated switch that actuates to the closed position when the remote switch is pushed;
wherein the remote switch forms a series electric connection between the remote power circuit and the remote transmitter;
wherein the remote transmitter is a radio frequency transmitter;
wherein the actuation of the remote switch to the closed position allows electricity to flow from the remote power circuit into the remote transmitter;
wherein the actuation of the remote switch initiates the remote transmitter to establish the remote wireless communication link with the remote receiver;
wherein the remote power circuit is an electrical circuit;
wherein the remote power circuit powers the operation of the remote control circuit.

14. The light control system according to claim 13
wherein the lamp power circuit comprises a lamp battery, a lamp diode, a lamp charging port, and an external power source;
wherein the external power source further comprises a charging plug;
wherein the lamp battery, the lamp diode, the lamp charging port, the external power source, and the charging plug are electrically interconnected;
wherein the carpet power circuit comprises a carpet battery, a carpet diode, a carpet charging port, and the external power source;
wherein the external power source further comprises a charging plug;
wherein the carpet battery, the carpet diode, the carpet charging port, the external power source, and the charging plug are electrically interconnected;
wherein the remote power circuit comprises a remote battery, a remote diode, a remote charging port, and the external power source;
wherein the external power source further comprises a charging plug;
wherein the remote battery, the remote diode, the remote charging port, the external power source, and the charging plug are electrically interconnected.

15. The light control system according to claim 14
wherein the lamp battery is a rechargeable battery;
wherein the lamp charging port is an electrical circuit that reverses the polarity of the rechargeable lamp battery;
wherein the lamp charging port forms an electrical connection to an external power source using a charging plug;
wherein the charging plug forms a detachable electrical connection with the lamp charging port;
wherein the lamp charging port receives electrical energy from the external power source through the charging plug;
wherein the lamp diode is an electrical device that allows current to flow in only one direction;
wherein the lamp diode installs between the rechargeable lamp battery and the lamp charging port such that electricity will not flow from a positive terminal of the rechargeable lamp battery into a positive terminal of the external power source;
wherein the carpet battery is a rechargeable carpet battery;
wherein the carpet charging port is an electrical circuit that reverses the polarity of the rechargeable battery;
wherein the carpet charging port forms an electrical connection to an external power source using a charging plug;
wherein the charging plug forms a detachable electrical connection with the carpet charging port;
wherein the carpet charging port receives electrical energy from the external power source through the charging plug;
wherein the carpet diode is an electrical device that allows current to flow in only one direction;
wherein the carpet diode installs between the rechargeable carpet battery and the carpet charging port such that electricity will not flow from a positive terminal of the rechargeable carpet battery into the positive terminal of the external power source;
wherein the remote control battery is a rechargeable battery;
wherein the remote control charging port is an electrical circuit that reverses the polarity of the rechargeable remote control battery;
wherein the remote control charging port forms an electrical connection to the external power source using a charging plug;
wherein the charging plug forms a detachable electrical connection with the remote control charging port;
wherein the remote control charging port receives electrical energy from the external power source through the charging plug;
wherein the remote control diode is an electrical device that allows current to flow in only one direction;
wherein the remote control diode installs between the rechargeable remote control battery and the remote control charging port such that electricity will not flow from a positive terminal of the rechargeable remote control battery into the positive terminal of the external power source.
